(19) United States
(12) Patent Application Publication
(10) Pub. No.: US 2010/0182654 A1
(43) Pub. Date: Jul. 22, 2010

(54) IMAGE FORMING DEVICE

(76) Inventors: Tasuku Kohara, Kanagawa (JP); Takashi Inoue, Saitama (JP); Kazuo Koike, Kanagawa (JP); Kenichi Yamada, Kanagawa (JP); Taisuke Omi, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/376,647

(22) PCT Filed: Aug. 9, 2007
(86) PCT No.: PCT/JP07/65930

§ 371 Date: Feb. 6, 2009

(30) Foreign Application Priority Data
Aug. 10, 2006 (JP) 2006-218310

(51) Int. Cl. H04N 1/04

(52) U.S. Cl. 358/474

(57) ABSTRACT

An image forming device including: a scanning device configured to acquire an image data of a manuscript; a processing device configured to form an image on a recording medium based on the image data; a main body of the image forming device having a first operation section configured to input an instruction to the image forming device; and a second operation section arranged at the main body of the image forming device. The image forming device acquires the image data of the manuscript and forms the image on the recording medium in accordance with an operation of at least one of the first and the second operation sections, the second operation section being operable at a low position compared to a position of the first operation section.

### CROSS-REFERENCE TO THE RELATED APPLICATION

The entire contents of Japanese patent application No. 2006-218310, filed on Aug. 10, 2006, of which the convention priority is claimed in this application, are incorporated hereinto by reference in their entirety.

### TECHNICAL FIELD

The present invention relates to an image forming device. In particular, this invention relates to a modification of an operating section of the image forming device.

### BACKGROUND ART

In recent years, it has become more common for persons to maintain their social life while performing some daily functions with supplementary welfare tools, etc., such as a wheelchair, due to an advancement of medical technology and a yearly increment in the average life span, and the opportunity for people with disabilities and aged persons, etc. to participate in society is ever-increasing, too.

From such a background, in society in general, a barrier-free trend has been promoted that removes inconveniences in social life encountered by such as people with a disability and aged persons, and in addition, for office automation apparatuses such as copiers which are used in such as an enterprise or a public organization, various proposals corresponding to a barrier-free state have been made (refer to JP 2000-214731 A, JP 2005-010394 A, JP 2005-300872 A and JP 2005-099567 A).

JP 2000-214731 A and JP 2005-010394 A disclose an image forming device in which a position of an image reading section provided at a main body of the device is capable of being moved up and down, by moving the main body of the device up and down. However, in such an image forming device, it is difficult to secure sufficient accessibility for a user who is in a state of sitting in such as a wheelchair, since a lower limit of a moving range of the image reading section depends on a height of the main body of the device. Moreover, a problem arises in that an increase in the cost of the device is caused by an enlargement of an up-and-down mechanism as the image forming device is enlarged in size.

JP 2005-300872 A and JP 2005-099567 A disclose an image forming device in which an image reading section is formed to be capable of moving up and down relative to a main body of the device. Due to a light moving section, an enlargement of an up-and-down mechanism of such an image forming device is not needed, which is necessary for the above-mentioned device, but it is difficult to secure sufficient accessibility for a user who is in a state of sitting in a wheelchair, etc. since a lower limit of a moving range of the image reading section depends on a height of the main body of the device, as well as the image forming device mentioned above.

In addition, to secure accessibility to an image reading section, an image forming device in which a pullout image reading section is provided at an arbitrary position of a main body of the image forming device, is proposed (for example, refer to JP H11-194566 A). However, when the image forming device is set up in an enterprise or a public organization, etc. based on a premise that the image forming device is used by an unspecified user, it is necessary that all the people including not only those with a disability and aged persons who use the welfare tools but also other people, are able to use it with ease. Therefore, it is not suitable that a height of the image reading section is fixed at one point depending on an installation location of the image forming device.

For example, in the case of an image forming device disclosed in JP 2005-10293 A, though it solved problems in a height direction, it is still difficult to operate since a wheelchair is positioned facing a side of an operation section of the imaging forming device whereas it is not possible to be positioned facing a front of the operation section when operating. Moreover, in the case of an image forming device disclosed in JP 2004-148567 A, during operation, though it is possible to position a wheelchair facing a front of an operation section of the image forming device, a user sitting in the wheelchair has to look into the operation section while bending the body forward, since the operation section is located at a high position for the user.

### DISCLOSURE OF THE INVENTION

### Problem to be Solved by the Invention

In light of the above, at least one object of the present invention is to provide an image forming device which is easy to operate, in particular when a user is a wheelchair user.

### Means for Solving the Problem

According to an aspect of the present invention, an image forming device includes: a scanning device configured to acquire an image data of a manuscript; a processing device configured to form an image on a recording medium based on the image data; a main body of the image forming device having a first operation section configured to input an instruction to the image forming device; and a second operation section arranged at the main body of the image forming device, the image forming device acquiring the image data of the manuscript and forming the image on the recording medium in accordance with an operation of at least one of the first and the second operation sections, the second operation section being operable at a low position compared to position of the first operation section.

Thus, by arranging the second operation section such that it is configured to be able to operate the image forming device at a position lower than the position of the first operation section, even for a person using a wheelchair or a short person, the operation becomes easy, in a state where the front door is opened. In particular, in the present invention, if the second operation section is unnecessary, for example when a tall person uses the image forming device or the device is in normal use, it is now possible to store the second operation section inside of the closed front door without any disturbance to the operation, and use only the first operation section.

### Effect of the Invention

According to the present invention, it is possible to provide an image forming device with improved operability, in particular when a wheelchair user is using the device, or maintenance is performed on the device.

### BRIEF DESCRIPTION OF THE DRAWINGS

The invention will be described further below with reference to embodiments and the accompanying schematic drawings, in which:

FIG. 1 is a perspective external view of an image forming device illustrating a structure of a main body of the image forming device (a second door being closed) according to a first embodiment of the invention;

FIG. 2 is a perspective external view of the image forming device illustrating a state in which the openable and closable second door of the main body of the image forming device is opened (a first opening stage of the door) according to an embodiment of the invention;

FIG. 3 is a side view illustrating the state in which the openable and closable second door of the main body of the image forming device is opened (the first opening stage of the door) according to an embodiment of the invention;

FIG. 4 is a perspective external view of the image forming device illustrating a state in which the second door is further opened (a second opening stage of the door) according to an embodiment of the invention;

FIG. 5 is a side view illustrating the state in which the second door is further opened (the second opening stage of the door) according to an embodiment of the invention;

FIG. 6 is a block view illustrating each of sections related to a control of the image forming device according to an embodiment of the invention;

FIG. 7 is a perspective external view of an image forming device illustrating a structure of a main body of the image forming device (a second door being closed) according to a second embodiment of the invention;

FIG. 8 is a perspective external view of the image forming device illustrating a state in which the second door is opened according to the second embodiment of the invention;

FIG. 9 is a front view illustrating a state in which the second door is opened according to the second embodiment of the invention;

FIG. 10 is a perspective external view of the image forming device illustrating a state in which the second door is opened according to a third embodiment of the invention; and

FIG. 11 is a front view illustrating a state in which an operation plane of a second operation section is horizontalized according to the third embodiment of the invention.

### DESCRIPTION OF NUMERALS

1 ADF
2 Catch tray
3 Paper tray
5 Scanner
7 First operation section
8, 8A Second operation section
9 Opening and closing sensor
10, 20 Front door
10A, 20A First door
10B, 20B Second door
11 LCD
12 Key matrix
13 Touch panel
14 LED matrix
15 Memory unit
16 Operation section control unit
17 Operation panel control unit
18 Main body control unit
19 Storage unit
21 Tilt mechanism
100 Main body of image forming device

### BEST MODE FOR CARRYING OUT THE INVENTION

### Embodiment 1

According to this invention, by providing a second operation section at a lower position, for example at an openable and closable door of a main body of an image forming device and enabling an operation of the operation section at a low position, operability during working is improved, even if the image forming device is used, for example, by a wheelchair user, etc.

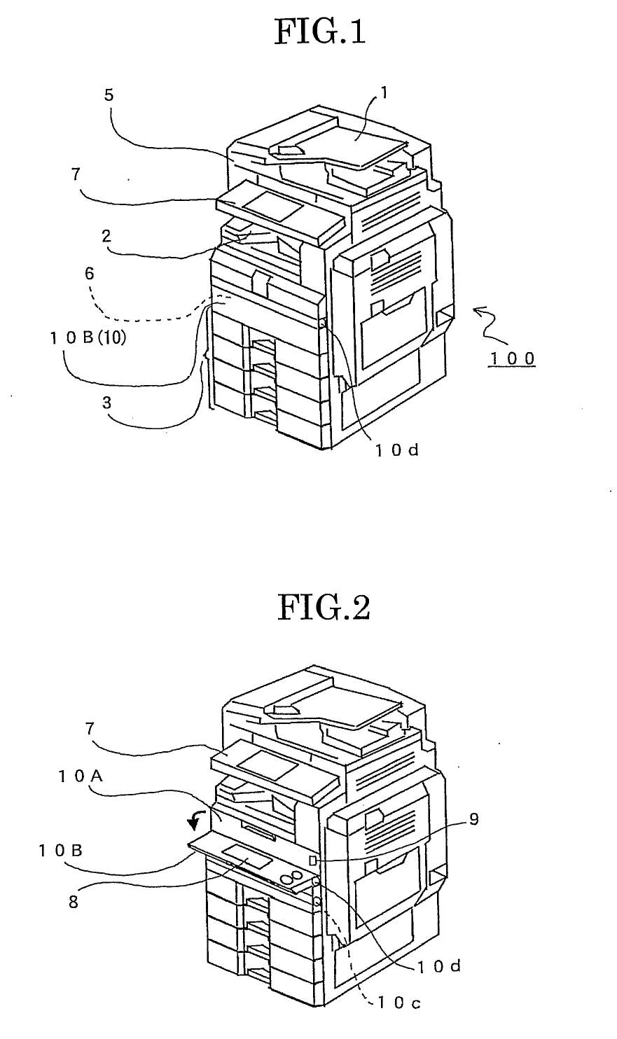

As illustrated in FIG. 1, a main body 100 of the image forming device includes an ADF (Automatic Document Feeder) 1 which sends a manuscript to a scanner section; a scanner 5 which captures the manuscript to be copied; a printer 6 which outputs a copied image (not illustrated as such in FIG. 1 due to the printer 6 being embedded in the main body); a paper tray 3 which houses recording media; two operation sections 7 and 8 (refer to FIG. 2); and a catch tray 2, as main functional components. Inside the main body 100, the above-mentioned paper tray 3 (4-stage in this embodiment), the image forming section (the printer 6), the internal catch tray (possibly not this catch tray depending on a type of the image forming device), the image capturing section (the scanner 5) and the catch tray 2 are provided, in this sequence from below. A detailed explanation of these components is omitted due to their being well-known.

The operation section (a first operation section) 7 having a display is provided at an upper part of a front of the main body 100 of the image forming device. The first operation section 7 includes a LCD 11, an operation section control unit 16, a touch panel 13, a key matrix 12, a LED matrix 14 and a memory unit 15. Operation buttons by which a user actually performs various inputs include such as a hard switch (a hard key with a key matrix), and a soft key with a touch panel, etc. A display device of LED or the like, or a display by LCD or the like is used for displaying an instruction from an operating state of the device or an equipment side.

A front door 10 is provided at a side surface viewed from a front direction of the main body 100 of the image forming device, and is located under the first operation section 7. The operation section (a second operation section) 8 is provided at an inner surface of the front door 10, and is displayed by opening a second door 10B. By the second operation section 8, it is possible to carry out the same operations performed by the first operation section 7, at a position lower than that of the first operation part 7. An operation panel control unit 17, a main body control unit 18, and a storage unit 19 of the main body, etc. are housed inside of the main body of the image forming device.

In this embodiment, the front door 10 is formed to be a rectangle and has a dual structure. The front door 10 includes an inside first door 10A and the outside second door 10B, the first door 10A being formed to be pulled out and downward towards a user side, and to be openable and closable, the second door 10B being formed to be openable and closable independently of the first door 10A, and be pivotally supported by a horizontal axis at a lower end part. In addition, the second operation section 8 is attached to the second door 10B. The first door 10A is opened and closed when the main body of the image forming device is maintained. An opening and closing sensor 9 which determines an opening and closing state of the attached second door 10B is provided at the first door 10A (refer to FIG. 2). The second door 10B is possible to be pivotally supported in a horizontal direction at two places, i.e. at its lower end part and nearly at its central part in an up-and-down direction by axes 10c and 10d, respectively, and be formed to be capable of opening in two stages forwardly. As illustrated in FIG. 2, at a normal time (the second door 10B is in a closed state), the first door 10A and the second door 10B are contacted and fixed by a retaining means such as magnets (not illustrated). Thus, when the second door 10B is in the closed state, the first operation section 7 is used to operate the image forming device. In addition, different from the embodiment, the first door 10A can be pivotally supported at a side end part and opened horizontally.

The second operation section 8 is possible to be provided at the main body 100 of the image forming device, or the front door 10 provided at the main body 100, or the second door 10B. In addition, the second operation section 8 is possible to be provided at an inner face of the openable and closable second door 10B of the main body 100 of the image forming device, thus, it does not mar the appearance even if the second operation section 8 is on display.

The second operation section 8 is also possible to be arranged at or attached to the openable and closable second door 10B of the main body 100 of the image forming device, in a state such that an operation plane of the second operation section 8 is facing the main body 100 of the image forming device. Thus it is possible to perform operations of the device directly when the second door 10B is opened.

The second operation section 8 is also possible to be attached to the inner face of the second door 10B which is openable and closable relative to the main body 100 of the image forming device, in a state such that the operation plane of the second operation section 8 is facing a side of the second door 10B which is openable and closable. In this manner, it is possible to protect a LCD display of the second operation section 8 from such as an impact or a foreign body during closing the door.

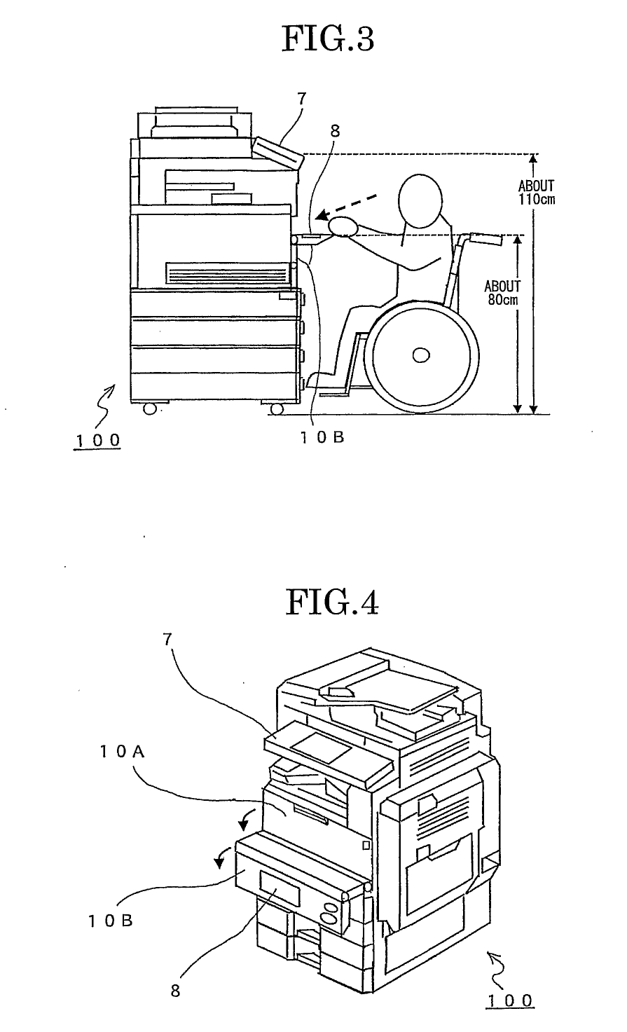

In addition, the second operation section 8 is possible to be provided at the inner face of the second door 10B, with an operation plane (surface) of the second operation section 8 facing a side of the first door 10A. The second operation section 8 is structured substantially identical to the first operation section 7. When the second door 10B is in a closed state, by drawing out a knob or the like with a force equal to or more than a certain power, the second door 10B becomes in a state illustrated in FIG. 2 and FIG. 3 (a first opening stage of the door). The second operation section is in a state such that its operation plane is facing the ceiling. At this time, a height of the first operation section is about 110 cm, and a height of the second operation section is about 80 cm.

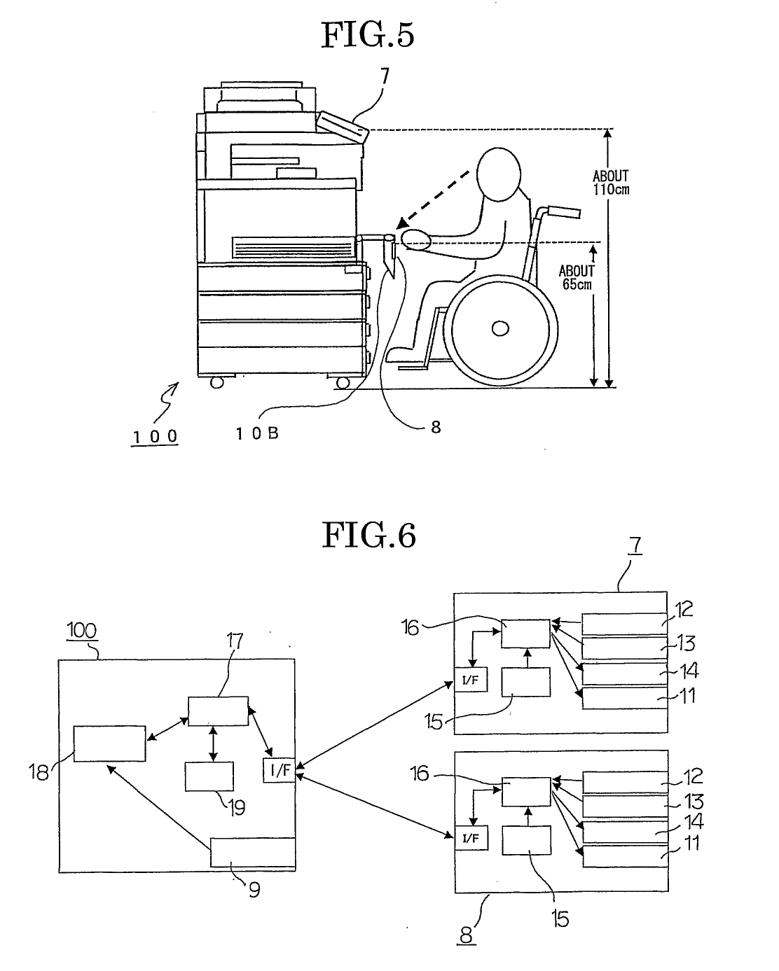

Moreover, by further pulling out the second door 10B from the state illustrated in FIG. 2 (and FIG. 3) towards the user, with the force equal to or more than the certain power, and turning the second door 10B to a prescribed position, the operation plane of the second operation section 8 is suspended to be in a state facing a direction of the user (a second opening stage of the door), as illustrated in FIG. 4 and FIG. 5. In this manner, a structure is achieved that permits the wheelchair user to look down at the downwardly suspended operation plane of the second operation part 8 from the above and operate it. At this time, the height of the first operation section 7 is about 110 cm, and the height of the second operation section 8 is about 65 cm. In addition, in each above-mentioned state, this structure has an advantage in that it is possible to suppress the projection of the second operation section 8 as much as is practically possible.

FIG. 6 is a block view illustrating each of units related to a control of the image forming device. Communications between the image forming device control unit and the operation section control unit 16 are performed as follows. The operation section control unit 16 controls each of the above-mentioned control units. At the same time, it communicates with the storage unit 15 or the control unit 18 of the main body side, and performs delivery and receipt of input data or display data. The first operation section 7 and the second operation section 8 always transfer data about their own states to the control unit 18 of the main body side, and the control unit 18 performs a switching between both operation sections to the operation section capable of being used, according to an output state of the opening and closing sensor 9.

In this embodiment, the device is controlled to invalidate an operation from the first operation section 7 when the second operation section 8 is possible to be used. That is, the device is controlled such that, as illustrated in FIG. 3 or FIG. 4, in a state when the openable and closable front door 10 of the main body 100 of the image forming device is opened, for determining the opening and closing state of the second door 10B, a recognition of a state in which the second door 10B is opened is performed by the opening and closing sensor 9 attached to the first door 10A, and when the second door 10B is in an opened state and the second operation section 8 is displayed, an operation signal from the second operation section 8 is given priority, and only the second operation section 8 is possible to be used, while the first operation section 7 is in a state of being unusable. Thus, by invalidating the first operation section when using the second operation section, it is possible to prevent, for example, unintended unnecessary input from the first operation section when the second operation section is in use.

In addition, the image forming device has an acquiring unit to acquire form data of the first and the second operation sections 7, 8, and when the second door 10B is closed while the image forming device is being operated by the second operation section 8, the first operation section 7 becomes possible to be used, and operation screen data, etc. of the second operation section 8 is transferred to the first operation section 7, and is possible to be used continuously without change.

### Embodiment 2

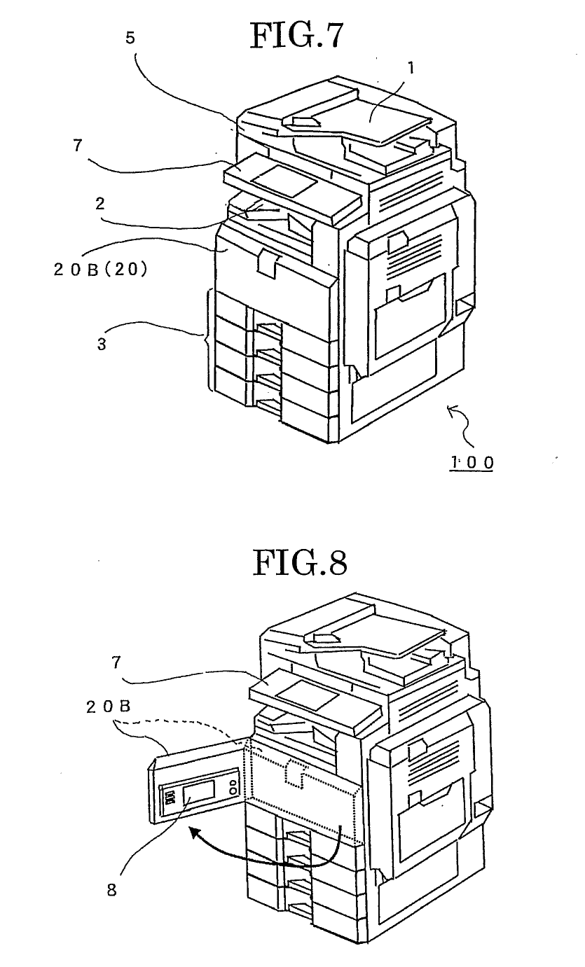

In the above-mentioned first embodiment, although the second door 10B provided with the second operation section 8 is formed to be pulled out and downward towards the user side, and be openable and closable, it is also possible to apply an image forming device with a front door openable and closable in a side direction of a main body of the image forming device (turning in a horizontal direction in a horizontal plane) to this invention, and to provide a similar second operation section at the front door. FIG. 7 is a perspective external view of such an image forming device according to the second embodiment. In this embodiment, a front door 20 is arranged to be located under the first operation section 7, and the front door 20 is openable and closable in a side direction of the main body of the image forming device (a horizontal direction, a lateral direction).

The front door 20 is formed to be a rectangle and has a dual structure. The front door 20 includes an inside first door 20A and an outside second door 20B, the first door 20A being openable and closable in the lateral direction, the second door 20B being located outside the first door 20A and openable and closable in the lateral direction independently of the first door 20A. Both the first door 20A and the second door 20B are contacted and fixed disengageablely by a retaining means (not illustrated). In addition, the second operation section 8 is attached to the second door 20B. The first door 20A opens and closes when the main body of the image forming device is maintained. An opening and closing sensor 9 similar to the above-mentioned sensor is provided at the first door 20A.

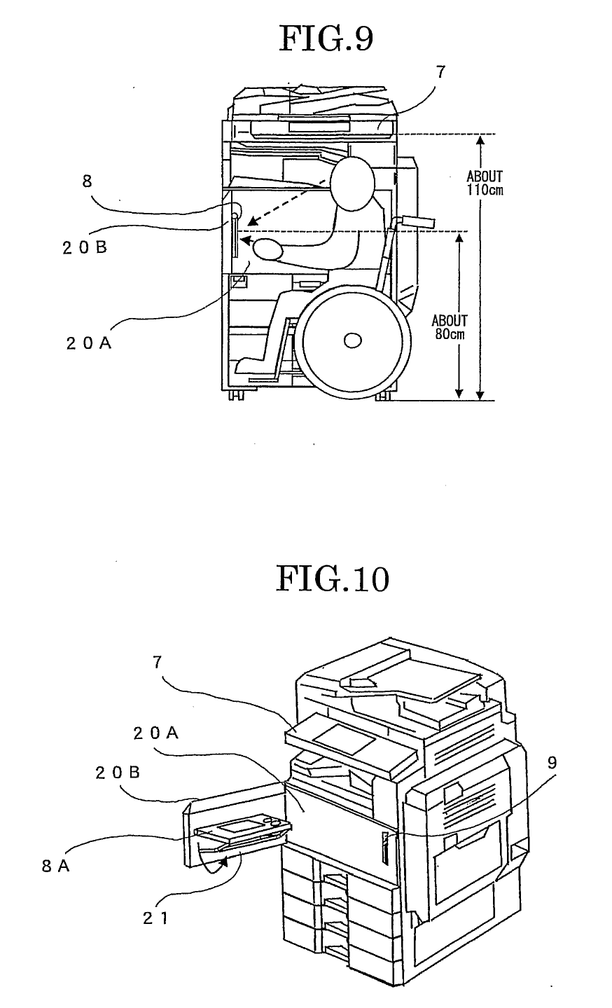

As illustrated in FIGS. 8 and 9, the second operation section 8 is provided at the second door 20B such that its operation plane is facing a direction of the user. At this time, a height of the first operation section 7 is about 110 cm, and a height of the second operation section 8 is about 80 cm.

Since other components and structures are similar to those of the above-mentioned embodiment and the same reference numbers as the above-mentioned embodiment are attached, a detail explanation of them is omitted. In addition, both the operation sections 7 and 8 are able to be controlled by a similar method as above-mentioned, i.e. giving priority to the second operation section 8. An explanation of this method is omitted here. Alternatively, it is possible to control the first and the second operation sections 7, 8 to operate in parallel (simultaneous use).

According to this embodiment, it is also possible to provide an image forming device which is easy to be operated, in particular when the user is a wheelchair user. According to this structure, although the wheelchair is placed in the same direction as the original case, the wheelchair is facing the operation section of the image forming device, in addition the operation section is arranged at the height of 80 cm where it is easy to operate for the wheelchair user, thus the user is able to operate the image forming device without facing the side of the operation section, and also it is not necessary to look into the operation section with the body bending forward.

### Embodiment 3

FIG. 10 is a perspective external view of the image forming device according to the third embodiment of the invention, illustrating a state in which the second door 20B which is openable in the lateral direction is opened, and a second operation section 8A provided at the inner face of the second door 20B is started up. The image forming device according to this embodiment has a substantially similar appearance to that of the image forming according to the above-mentioned embodiment (refer to FIG. 7). That is, the front door 20 is openable and closable in the side direction of the main body of the image forming device, outside the first door 20A the second door 20B is pivotally supported which is turnable and is openable and closable, and the second operation section 8A is provided on an inner face side of the second door 20B and is housed in a state such that an operation plane of the second operation section 8A is facing the direction of the user. This operation section 8A is possible to be operated in a state such that its operation plane is facing the direction of the user (refer to FIG. 8). In addition, since the operation section 8A according to this embodiment has a tilt mechanism 21 which is a mechanism capable of fixing at a certain angle, and the user is able to adjust the operation section 8A to an arbitrary angle to operate the image forming device, it is possible to set a plurality of fixing positions.

In this manner, the second operation section 8A is provided with the angle adjusting mechanism (the tilt mechanism 21), therefore the operations of the device become easy in particular for such as a wheelchair user or a short person.

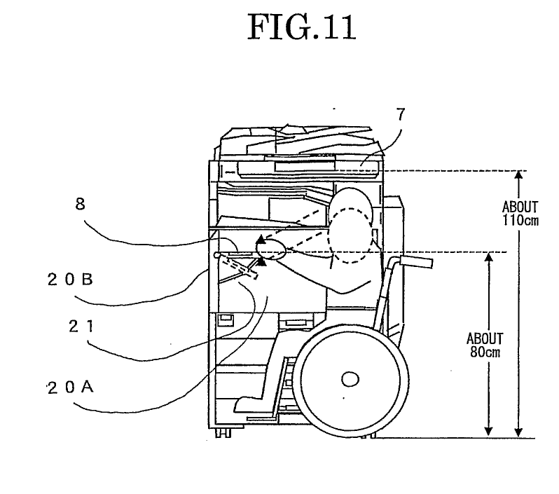

Moreover, by lifting the second operation section from a position illustrated in FIG. 10 with a force equal to or more than a certain power, the operation plane of the second operation section is in a state facing the ceiling, as illustrated in FIG. 11. For example, the second operation section 8A is fixed to a prescribed horizontal position by such as a ratchet. At this time, a height of the first operation section is about 110 cm, and a height of the second operation section is about 80 cm. Structures and controls of the other components are similar to those explained in the above-mentioned embodiment, and an explanation of them is omitted.

### Embodiment 4

Moreover, a simplified embodiment, which does not employ the above-mentioned structure of the second door according to the first embodiment, is possible. In the first embodiment, the second door is formed to be pulled out and downward towards the user side, and to be openable and closable (a broken-type structure). Further, it is possible to form the second door similar to the second door employed in the first embodiment with a single plate member pivotally supported at its lower end (not illustrated), an external view of such an image forming device being similar to that illustrated in FIG. 7. Other components are possible to be similar to those in the first embodiment, and an explanation of them is omitted.

As explained above, according to the present invention, by enabling the operation of the operation section at a low position, it is possible to improve the operability of the image forming device, in particularly when a wheelchair user, etc. uses the image forming device. In addition, the second operation section is possible to be housed inside of the door when it is not in use, resulting in no disturbance in operating, and thus the image forming device according to the present invention is more suitable. In addition, by enabling to set the first and the second operation sections to a maintenance mode with a specific operation, the first and the second operation sections are able to be utilized during maintenance, therefore it is possible to improve the operability of the image forming device.

In addition to each of the above-mentioned embodiments, various modifications are possible to be made to this invention. For example, it is possible to utilize a structure in the third embodiment such that the second operation section is biased to turn upward and downward around a lateral shaft, when the second door is opened from the main body of the image forming device, and the second operation section is disposed automatically to a prescribed easily viewable angle. Thus by such a structure, it is possible to perform the operations at an arbitrary angle, in addition when the second door 10B of the main body 100 of the image forming device is closed from the opening state, the second operation section 8A returns to a prescribed position naturally, and it is possible to prevent the second operation section 8A from being damaged due to being sandwiched by the second door 20B and the first door 20A.

Although the present invention has been explained in relation to its preferred embodiments and drawings but not limited thereto, it is to be understood that other possible modifications and variations made without departing from the spirit and scope of the invention will be included in the present invention. Therefore, the appended claims encompass all such changes and modifications as falling within the true spirit and scope of this invention.

### INDUSTRIAL APPLICABILITY

According to the present invention, it is possible to utilize an operation section of an image forming device at a low position, by providing a second operation section at an openable and closable door of a main body of the image forming device, therefore, an image forming device with improved operability is provided, in particular when a wheelchair user is using the device, or maintenance is performed on the device.

1. An image forming device, comprising:
a scanning device configured to acquire an image data of a manuscript;
a processing device configured to form an image on a recording medium based on the image data;
a main body of the image forming device having a first operation section configured to input an instruction to the image forming device; and
a second operation section which is arranged to be housed and which is arranged at a side of a front door formed at a side surface of a front side of the image forming device,
the image forming device acquiring the image data of the manuscript and forming the image on the recording medium in accordance with an operation of at least one of the first and the second operation sections, the second operation section being operable at a low position compared to position of the first operation section, and an angle of an operation plane of the second operation section being adjustable.

2. An image forming device according to claim 1, wherein the front door includes a dual structure having an inside first door and an outside second door, the first door being pivotally supported at one end, the second door being openable and closable independently of the first door,
wherein the second operation section is provided at the second door.

3. An image forming device according to claim 1, wherein the second operation section is arranged at or attached to an openable and closable second door provided at the main body of the image forming device, in a state such that the operation plane of the second operation section is facing the main body of the image forming device.

4. An image forming device according to claim 1, wherein the second operation section is attached to an inner face of a second door which is provided at the main body of the image forming device and is openable and closable relative to the main body of the image forming device, in a state such that the operation plane of the second operation section is facing a side of the second door which is openable and closable.

5. An image forming device according to claim 1, wherein the image forming device comprises an angle adjustment mechanism which fixes the second operation section at a certain angle when a second door which is provided at the main body of the image forming device and which is provided with the second operation section is opened relative to the main body of the image forming device.

6. An image forming device according to claim 1, wherein a second door provided at the main body of the image forming device is pivotally supported at one side end by a vertical shaft and turns in a lateral direction, and when the second door is opened from the main body of the image forming device, the second operation section turns upward and downward around a lateral direction shaft.

7. An image forming device according to claim 1, wherein the image forming device comprises an invalidation unit which is configured to invalidate the first operation section when the second operation section is in use.

8. An image forming device according to claim 1, wherein the image forming device comprises an acquiring unit which is configured to acquire operation history data of the first and the second operation sections.

9. An image forming device according to claim 1, wherein the first and the second operation sections are capable of being set to a maintenance mode with a specific operation.
